(19) United States
(12) Patent Application Publication
(10) Pub. No.: US 2026/0153629 A1
(43) Pub. Date: Jun. 4, 2026

(54) INTEGRATION OF IONOSPHERIC CORRECTION FOR GLOBAL NAVIGATION SATELLITE SYSTEM (GNSS) POSITIONING

(71) Applicant: QUALCOMM Incorporated, San Diego, CA (US)

(72) Inventors: Yuxiang PENG, San Jose, CA (US); Lorenzo BOTTER, Stanford, CA (US); Kannan MUTHURAMAN, Mission Viejo, CA (US); Ning LUO, Cupertino, CA (US)

(21) Appl. No.: 18/967,369

(22) Filed: Dec. 3, 2024

(51) Int. Cl. G01S 19/07; G01S 19/39

(52) U.S. Cl. CPC G01S 19/072; G01S 19/393

(57) ABSTRACT

Techniques for filtering iono correction data for global navigation satellite system (GNSS) positioning are provided which involve determining a threshold, or mask, for iono correction filtering based on a statistical analysis of variance data included in iono correction data and resulting residual information determined using the iono correction data. The mask can subsequently be used as a threshold to filter iono correction data based on its variance data. In some examples, a server can determine the mask based on crowdsourced information received from multiple GNSS receivers. In other examples, a GNSS receiver may determine the mask based on obtained iono correction data and GNSS measurements it makes itself. When applying the mask to filter incoming iono correction data. When incoming iono correction data is filtered, a GNSS device may use alternative iono correction techniques to perform iono correction, in some embodiments.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. Further, Satellite-Based Augmentation System, or SBAS, is a system that improves the accuracy of GNSS positioning by providing wide-area corrections for GNSS range errors. SBAS can include various corrections, including ionospheric correction information. Ionospheric correction may come from alternative sources as well.

### BRIEF SUMMARY

Techniques for filtering ionospheric, or “iono,” correction data for global navigation satellite system (GNSS) positioning provided in this disclosure involve determining a threshold, or mask, for iono correction filtering based on a statistical analysis of variance data included in iono correction data and resulting residual information determined using the iono correction data. The mask can subsequently be used as a threshold to filter iono correction data based on its variance data. In some examples, a server can determine the mask based on crowdsourced information received from multiple GNSS receivers. In other examples, a GNSS receiver may determine the mask based on obtained iono correction data and GNSS measurements it makes itself. When applying the mask to filter incoming iono correction data. When incoming iono correction data is filtered, a GNSS device may use alternative iono correction techniques to perform iono correction, in some embodiments.

An example method of supporting global navigation satellite system (GNSS) positioning of a GNSS device, according to this disclosure, comprises obtaining GNSS measurement data indicative of a plurality of GNSS measurements, and obtaining ionospheric correction data applicable to the plurality of GNSS measurements. The ionospheric correction data may include, for each GNSS measurement of the plurality of GNSS measurements: correction information indicative of an ionospheric delay correction, and variance information indicative of a variance or uncertainty of the correction information. The method may further comprise determining an ionospheric correction variance threshold based at least in part on the plurality of GNSS measurements and the variance information for the plurality of GNSS measurements, and providing an output indicative of the ionospheric correction variance threshold.

An example apparatus for supporting global navigation satellite system (GNSS) positioning of a GNSS device, according to this disclosure, comprises at least one transceiver, at least one memory, and at least one processor communicatively coupled with the at least one transceiver and at least one memory. The at least one processor is configured to obtain GNSS measurement data indicative of a plurality of GNSS measurements, and obtain ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information. The at least one processor may be further configured to determine an ionospheric correction variance threshold based at least in part on the plurality of GNSS measurements and the variance information for the plurality of GNSS measurements, and provide an output indicative of the ionospheric correction variance threshold.

Another example apparatus, according to this disclosure, comprises means for obtaining global navigation satellite system (GNSS) measurement data indicative of a plurality of GNSS measurements, and means for obtaining ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information. The apparatus may further include means for determining an ionospheric correction variance threshold based at least in part on the plurality of GNSS measurements and the variance information for the plurality of GNSS measurements, and means for providing an output indicative of the ionospheric correction variance threshold.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a global navigation satellite system (GNSS) system, according to an embodiment.

FIG. 2 is a figure comparing positioning results using ionospheric correction data from Satellite-Based Augmentation System (SBAS) with results using traditional ionospheric correction models, according to an example.

FIG. 3 is a flow diagram of process by which an ionospheric correction data mask (e.g., a variance threshold) may be determined, according to an embodiment.

FIG. 4 is a flow diagram of a process of location estimation using an ionospheric correction data mask, according to an embodiment.

FIGS. 5A and 5B are graphs showing an example improvement that filtering iono correction in the manner described in the embodiments herein may provide.

FIGS. 6A and 6B are graphs similar to those shown in FIGS. 5A and 5B but using a different constellation and data set.

FIG. 7 is a flow diagram of a method of supporting GNSS positioning of a GNSS device, according to an embodiment.

FIG. 8 is a block diagram of an embodiment of a GNSS device.

FIG. 9 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “user equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, a GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” or “satellite vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, a GNSS device may determine a more accurate GNSS-based position fix by using ionospheric, or “iono,” correction to reduce ionospheric errors in measurements of GNSS signals made by the GNSS device. Iono correction may be provided by a service, such as Satellite-Based Augmentation System (SBAS), which may typically provide more accurate results than using traditional ionospheric modeling techniques. However, this is not always the case. In some instances, using correction information provided by an iono correction service may result in a less-accurate GNSS-based position fix.

Embodiments address these and other issues by providing techniques for filtering iono correction data. Generally put, these techniques involve determining a threshold, or mask, for iono correction filtering based on a statistical analysis of variance data included in iono correction data and resulting residual information determined using the iono correction data. The mask subsequently can be used as a threshold to filter iono correction data based on its variance data. In some examples, a server can determine the mask based on crowdsourced information received from multiple GNSS receivers. In other examples, a GNSS receiver may determine the mask based on obtained iono correction data and GNSS measurements it makes itself. When applying the mask to filter incoming iono correction data. When incoming iono correction data is filtered (e.g., exceeds the threshold), a GNSS device may use alternative iono correction techniques (e.g., models or iono-free combinations) to perform iono correction, in some embodiments. Details regarding these various techniques are provided in the embodiments described herein.

Particular aspects of the subject matter described in this disclosure can be implemented to realize one or more of the following potential advantages. In some examples, by using a mask to filter iono correction data, the described techniques can enable GNSS devices to provide more robust, more accurate GNSS position fixes using iono correction data. Furthermore, different masks may be determined for different iono correction types (e.g., different SBAS services), allowing filtering to be specifically “tuned” for to different geographical regions. These and other advantages will be apparent to a person of ordinary skill in the art in view of the embodiments described below.

Various embodiments are provided in detail hereafter following a review of applicable technology.

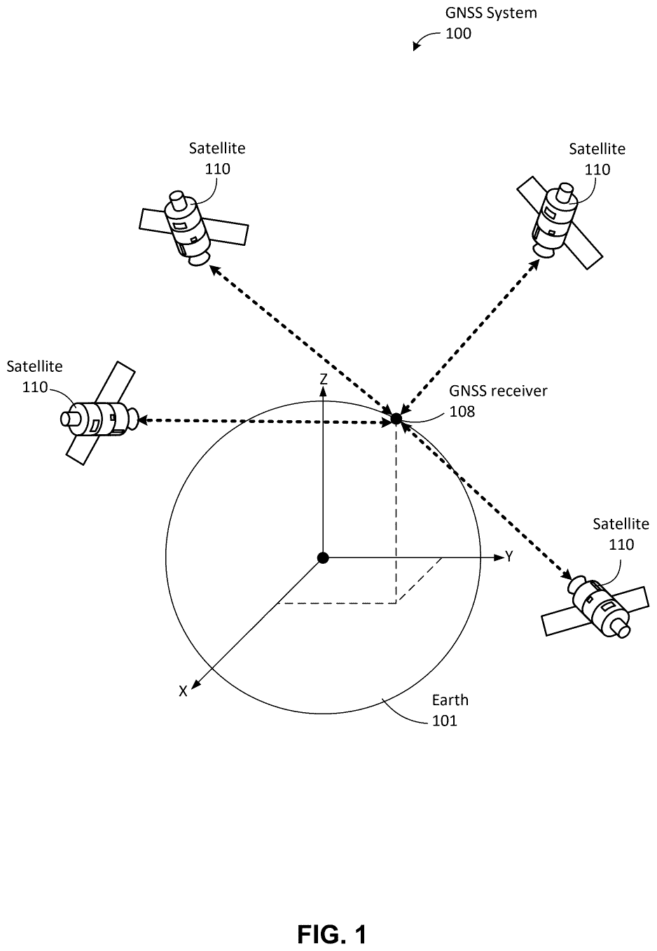

FIG. 1 is a simplified diagram of a GNSS system 100, provided to illustrate how GNSS is generally used to determine an accurate location of a GNSS receiver 108 on earth 101 (also known as “positioning” of the GNSS receiver). Put generally, the GNSS system 100 enables an accurate GNSS position fix of the GNSS receiver 108, which receives RF signals from GNSS satellites (or SVs) 110 from one or more GNSS constellations. The types of GNSS receiver 108 used may vary, depending on the application. In some embodiments, for instance, the GNSS receiver 108 may comprise a standalone device or component incorporated into another device. This can include, for example, consumer electronics or devices, such as a mobile phone, tablet, laptop, wearable device, vehicle (or in-vehicle device), or the like. In some embodiments, the GNSS receiver 108 may be integrated into industrial or commercial equipment, such as survey equipment, Internet of Things (IoT) devices, etc.

It will be understood that the diagram provided in FIG. 1 is greatly simplified. In practice, there may be dozens of satellites 110 in a given GNSS constellation, and many different types of GNSS systems with corresponding constellations. As noted, GNSS systems include global positioning system (GPS), Galileo, Global Navigation Satellite System (GLONASS or GLO), or BeiDou Navigation Satellite System (BDS), Quasi-Zenith Satellite System (QZSS), Indian Regional Navigational Satellite System (IRNSS), etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), BeiDou satellite-based augmentation system (BDSBAS), Geo Augmented Navigation system (GAGAN), and/or the like. SBAS is also described in further detail hereafter.

GNSS positioning is based on trilateration/multilateration, which is a method of determining position by measuring distances to points at known coordinates. In general, determining the position of a GNSS receiver 108 in three dimensions may rely on determining the distance between the GNSS receiver 108 and four or more satellites 110. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 110 and the GNSS receiver 108 may be determined using precise measurements made by the GNSS receiver 108 of a difference in time from when an RF signal is transmitted from the respective satellite 110 to when it is received at the GNSS receiver 108. To help ensure accuracy, not only does the GNSS receiver 108 need to accurately determine when the respective signal from each satellite 110 is received, but many additional factors need to be considered and accounted for. These factors include, for example, clock differences at the GNSS receiver 108 and satellite 110 (e.g., clock bias), a precise location of each satellite 110 at the time of transmission (e.g., as determined by the broadcast ephemeris), the impact of atmospheric distortion (e.g., ionospheric and tropospheric delays), and the like.

To perform a traditional GNSS position fix, the GNSS receiver 108 can use code-based positioning to determine its distance to each satellite 110 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 110, the GNSS receiver 108 can then determine a position fix for its location. For example, this position fix may be determined by a Standalone Positioning Engine (SPE) executed by one or more processors of the GNSS receiver 108. However, code-based positioning is relatively inaccurate and, without error correction, and is subject to many of the previously described errors. Even so, code-based GNSS positioning can provide a positioning accuracy for the GNSS receiver 108 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 110 observed by the GNSS receiver 108 can be mitigated or canceled based on similar carrier-based ranging of the satellites 110 using a highly accurate GNSS receiver at the base station at a known location. These measurements and the base station's location can be provided to the GNSS receiver 108 for error correction. This position fix may be determined, for example, by a Precise Positioning Engine (PPE) executed by one or more processors of the GNSS receiver 108. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 110 may be members of a single satellite constellation, i.e., a group of satellites that are part of a GNSS system, e.g., controlled by a common entity such as a government, and orbiting in complementary orbits to facilitate determining positions of entities around the world. One or more of the satellites 110 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites; the X-band, used by the military and for RADAR applications; and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As previously noted, SBAS is a wide area differential GNSS signal augmentation system that uses a number of satellites, able to cover vast areas, to broadcast primary GNSS data, which has been provided with ranging, integrity, and correction info. There are multiple SBAS services around the world that each cover a specific region with different service. As previously noted, these may include WAAS (in North America), GAGAN (in India), EGNOS (in Europe), BDSBAS (in China), and others. For all SBAS correction products, the iono correction is a regional ionospheric products containing real-time ionospheric delay information based on grid points. Further, although there may be alternatives to iono correction, such using an “ionosphere-free combination” in which multiple frequency bands are used to cancel out iono error, there are often downsides and limitations to such alternatives. For example, ionosphere-free combinations often increase noise, may be particularly vulnerable to multipath, and often require more power to perform a position fix. Further, there may be various situations in which only a single frequency band is available (e.g., due to spoofing, jamming, multipath, etc.).

Other iono correction sources also exist. GNSS signals also broadcast iono correction model parameters, such as GPS Klobuchar and Gaileo NeQuick models. Further, besides SBAS, there are other real-time iono products such as Quasi-Zenith Satellite System (QZSS) Centimeter Level Augmentation Service (CLAS) State Space Representation (SSR) and International GNSS Service (IGS) Ionosphere Exchange (IONEX). Similar to SBAS, these other iono correction sources can be used by a GNSS receiver to apply iono correction to GNSS measurements made by the GNSS receiver. Compared with standard broadcast iono correction (e.g., Klobuchar) iono correction products such as SBAS and QZSS CLAS SSR, can reduce GNSS measurement residuals and improve overall positioning accuracy.

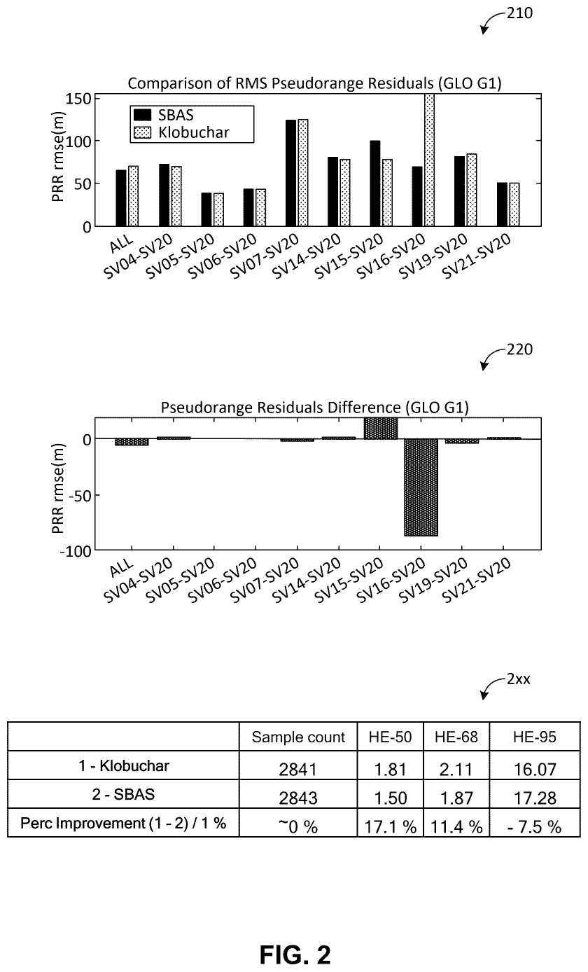

However, this is not always the case. In a single-difference (SD) GNSS residual analysis, the GNSS pseudorange (PR) measurement residual using SBAS iono correction can be worse (e.g., have a larger root mean square (RMS)) than using a traditional Klobuchar iono model. An example of this is provided in FIG. 2, described below.

FIG. 2 is a figure showing results of a comparison of GNSS measurement pseudorange (PR) residuals using traditional Klobuchar iono model with GNSS measurement residuals using SBAS correction on a sample data set of GNSS measurements of RF signals transmitted by various satellites using the GLO G1 band. The first graph 210 of the root mean square error (rmse) of PR residuals (PRR) for various different GLO satellites, using a traditional Klobuchar iono model and using SBAS correction. As can be seen, for at least one satellite (SV15-SV20), usage of the traditional Klobuchar iono model resulted in smaller residuals (e.g., better performance) then using SBAS correction. These differences in performance are highlighted in the second graph 220, in which plots the difference in PR residual values between using a traditional Klobuchar iono model and using SBAS correction for each satellite. And the second graph 220, positive values represent satellites for which traditional Klobuchar iono model outperformed the SBAS correction. Finally, table 230 shows a PPP log using SBAS vs Klobuchar iono models for a particular data set in which SBAS horizontal error (HE) with a percentile of 95% (R 95) is worse than using Klobuchar model. Of course, data can vary depending on the situation, but the data in FIG. 2 demonstrates how using iono correction such as SBAS correction may not necessarily improve robustness in all circumstances.

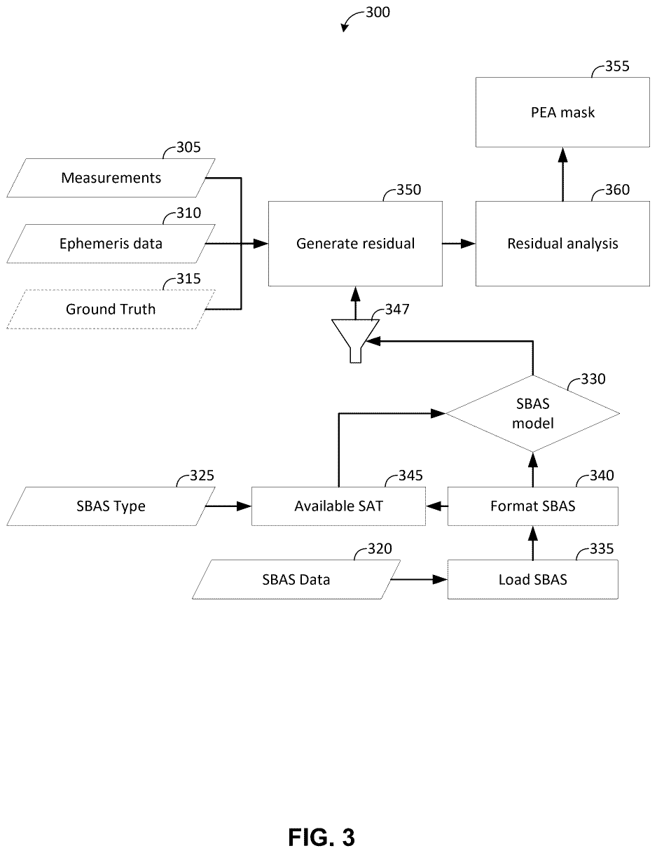

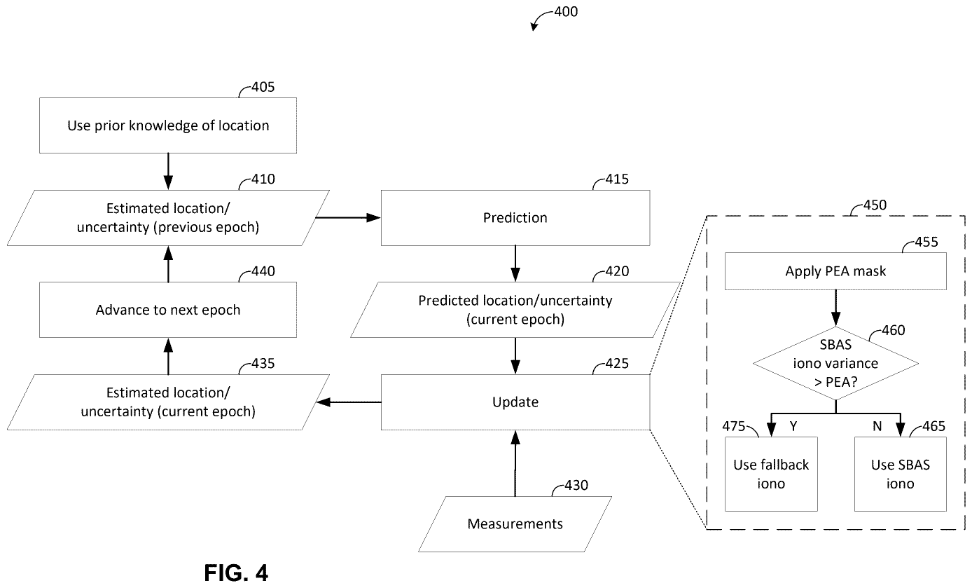

Embodiments address this by providing a solution in which iono correction may be filtered to improve robustness of iono product integration into a GNSS solution. To do so, embodiments may leverage uncertainty or variance values included in iono correction data, which is often ignored. According to various embodiments, this solution may comprise two parts: (1) determining a percentage error amplitude (PEA) mask (also referred to herein as an “ionospheric correction variance threshold” or “variance threshold”), and (2) the using the PEA mask to filter iono correction data for a GNSS position fix. Depending on desired functionality, one or both of these parts may be performed by a GNSS receiver, or a server may perform at least a portion of these parts (e.g., part (1)). Parts (1) and (2) are illustrated in FIGS. 3 and 4, respectively, and as described in more detail below.

An example of variance or uncertainty typically provided in iono correction data is SBAS total electron count (TEC) variance (TEC^{var}). SBAS TEC variance may be computed based on an SBAS grid using methods developed by the Radio Technical Commission for Aeronautics (RTCA). Because SBAS TEC variance is scaled by an elevation-dependent slant factor, there is a strong correlation between elevation and TEC variance. According to embodiments, the PEA mask may be used to “decouple” this correlation, which can avoid elevation bias, assuming 1σ as an error. As such, PEA may be derived from a statistical observation of an overall TEC variance pattern that may include an average variational coefficient and/or median TEC variance. PEA can be represented, for example, by the percentage of ionospheric delay over total residual error. One way to determine the PEA may be to take an average of percentage error across the entire time windows using multiple (e.g., >3) logs. Ultimately, a PEA mask value may be chosen to take into consideration both the absolute value and the variation of the TEC. A PEA mask (or PEA threshold) may be determined using regression runs of residual generation and residual analysis as shown in FIG. 3, for example.

It can be noted that a different PEA mask may be determined for each iono correction source type. For example, a different PEA mask (or variance threshold) may be used for WAAS than for GAGAN or EGNOS. Put differently, a PEA mask may be trained/tuned for a particular iono correction source. The process 300 and FIG. 3 may be performed for each correction source type.

FIG. 3 is a flow diagram of process 300 by which a PEA mask may be determined, according to an embodiment. This PEA mask may then be used as a filter with which SBAS correction data (e.g., including SBAS TEC variance) may be processed. As with other figures provided herein, FIG. 3 is provided as an example. Alternative embodiments may include additional or alternative operations and/or may otherwise vary from the functionality illustrated in FIG. 3, while providing the same general functionality. A person of ordinary skill in the art will appreciate such variations. In particular, although FIG. 3 explicitly indicates the use of SBAS correction data, alternative embodiments may use additional or alternative iono correction sources.

The process 300 may use various types of data sources. As shown, this may include GNSS measurement data 305, ephemeris data 310 (which may be included in the GNSS signal), and (e.g., if available) ground truth data 315. (Note, this process may be performed without ground truth data 315, but the accuracy may be degraded.) Additionally, the process 300 uses SBAS information including the SBAS data 320 itself (e.g., as received by the iono correction provider), along with the SBAS type 325. (Because a PEA mask may be specific to a particular SBAS type, as previously noted, the SBAS type 325 is taken into account in the process 300, and a different PEA mask (e.g., different threshold) may be determined for different SBAS types.)

The process 300 may then involve determining an SBAS model 330, which can include common operations for using an SBAS model, such as loading the SBAS information, shown at block 335, and formatting the SBAS information, shown at block 340 in accordance with SBAS processing, which can be done for a particular satellite, as shown at block 345. The SBAS model 330 may include the iono correction (e.g., absolute value of TEC) as well as the variance (e.g., SBAS TEC variance) in a format that may be used for residual determination. The output of this SBAS model 330 may be optionally filtered (as shown by filter 347), then used with measurements 305, ephemeris data 310, and (e.g., optionally) ground truth 315 to generate residual information, as indicated at block 350. In this example, filter 347 represents an optional filtering function that may be used to fuse SBAS iono information into the residual generation process. Depending on desired functionality, filter 347 may or may not include a previously-determined PEA. For example, in a first step, no PEA is known so all SBAS iono information is fed into the residual via filter 347 (e.g., no PEA-based filtering is performed). Once PEA is known, the residual generation process may be performed again to get more accurate residuals with filter 347 performing filtering with the previously-determined PEA.

At block 355, the process includes generating the PEA mask from a residual analysis, shown at block 360, of the residuals generated at block 350. For example, an optimal PEA mask (or a few candidate PEA masks) may be determined via regression runs. In this context, the “optimal PEA mask” may be the candidate that has a desired trade-off between minimizing RMS of measurement residuals and excluding or losing available SBAS iono correction. This balance may be implementation-specific according to some embodiments. According to some data processed by the inventors, a PEA mask value of 5.5% was determined to be a useful PEA mask when processing iono correction data from WAAS (SBAS regional service for North America). Other iono sources, including other SBAS providers, may have different PEA mask values.

Depending on desired functionality, the data at block 305-315 may be specific to a single receiver or may be obtained from multiple receivers. As previously noted, the process 300 may be performed at a GNSS receiver, in which case the GNSS receiver may provide the measurements 305, ephemeris data 310, and (optionally) ground truth information 315. Additionally, or alternatively, a server may perform the process 300, in which case the data at box 305-315 may be specific to a single receiver or may be obtained from multiple receivers. In the latter case, the server may obtain this information using crowdsourcing, in which case various GNSS receivers may provide this information to the server over a period of time.

It can be further noted that the window of time for which data is used for PEA mask determination may vary, depending on desired functionality. In other words, because PEA mask determination is performed using a statistical analysis of data (e.g., average variational coefficient and/or median variance of TEC, as noted above), the window of time for which data is collected and analyzed may vary. Some embodiments may perform a PEA mask determination for a window of time spanning one minute. The window of time in other embodiments may span days, weeks, etc. Yet other embodiments may be longer or shorter than these example time periods, again, depending on desired functionality.

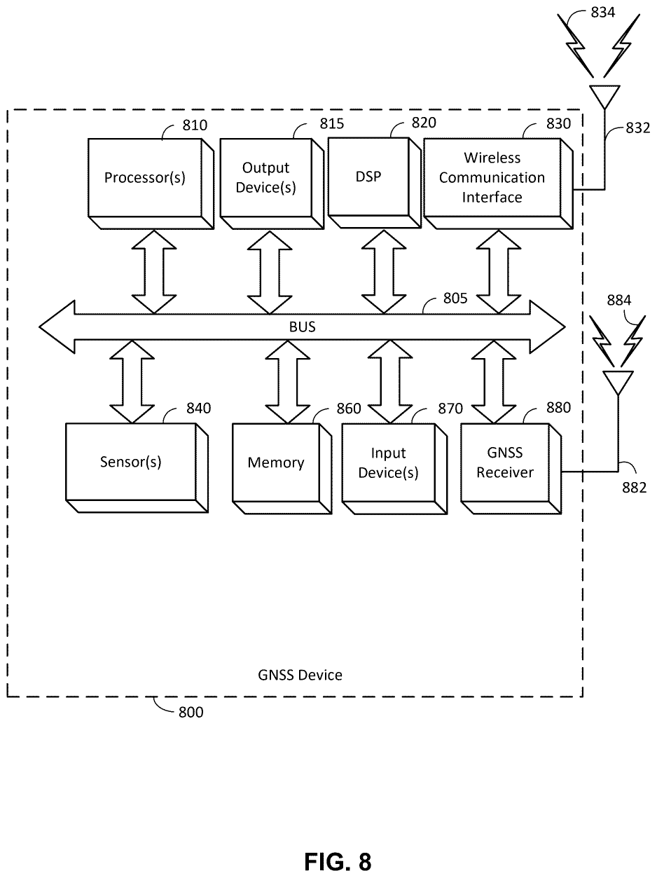

FIG. 4 is a flow diagram of a process 400 of location estimation using a PEA mask, according to an embodiment. The PEA mask may be determined using the process 300 illustrated in FIG. 3 and described above, for example. Further, the process may be performed by a GNSS device as part of a GNSS position fix. Further, hardware and/or software components of a GNSS device that may be used to perform any or all of the functionality of the process 400 are illustrated in FIG. 8, described below.

It can be noted that the process 400 may be seen as a variation to a Kalman Filter (KF) commonly used for GNSS positioning. For example, the functionality at blocks 405-440 comprise operations that may be performed by a GNSS receiver to perform the prediction and update functions of a KF. More specifically, traditional KF functionality may include the functionality shown at block 405 in which prior knowledge of a location may be used to determine an initial estimated location and uncertainty for a previous epoch. This initial estimated location and uncertainty then may be used in the prediction step, shown at block 415, to output a predicted location and uncertainty for a current epoch, shown at block 420. The update step shown at block 425 may then be performed using the predicted location and uncertainty along with GNSS measurements, shown at block 430. These measurements are made by the GNSS receiver to determine an estimated location and uncertainty for the current epoch, shown at block 435, which may be viewed as an update to the predicted location and uncertainty at block 420. The process may then advance to the next epoch, as shown by block 440, at which point the operations at block 410-440 may repeat to subsequently update the location of the GNSS receiver.

The PEA mask may be used to modify the update operation of the KF at block 425 as indicated in the functionality of the callout box 450. This may begin with the process illustrated at block 455, in which the PEA mask is applied to SBAS iono correction variance for the satellites used for GNSS positioning. For each satellite, it is then determined whether the SBAS iono correction variance is greater than the PEA mask, as shown at block 460. If SBAS iono correction variance is not larger than the PEA mask, then the SBAS iono correction is used for that satellite, as indicated at block 465. Otherwise, if SBAS iono correction variance is larger than the PEA mask, the process 400 can disregard the SBAS iono correction for that satellite and use fallback iono correction, as indicated at block 475.

In this context, using a fallback iono correction may mean using any of a variety of alternatives to the SBAS iono correction. For example, a GNSS device may fall back to a default iono model (e.g., Klobuchar) for that satellite or use an iono-free combination for the satellite. In some embodiments, a GNSS device may strongly de-weigh the GNSS measurement for which the SBAS iono variance exceeded the PEA mask. De-weighing the GNSS measurement may be done, for example, by scaling the uncertainty matrix used in the KF by a scale factor. For instance, an uncertainty matrix R may be scaled by a scale factor SF as follows: R^{new}=¿ R^{old}+SF·TEC^{var}. (This scale factor may be an empirically obtained coefficient determined from a large set of sample data.) This scaling can help make the uncertainty matrix more accurate.

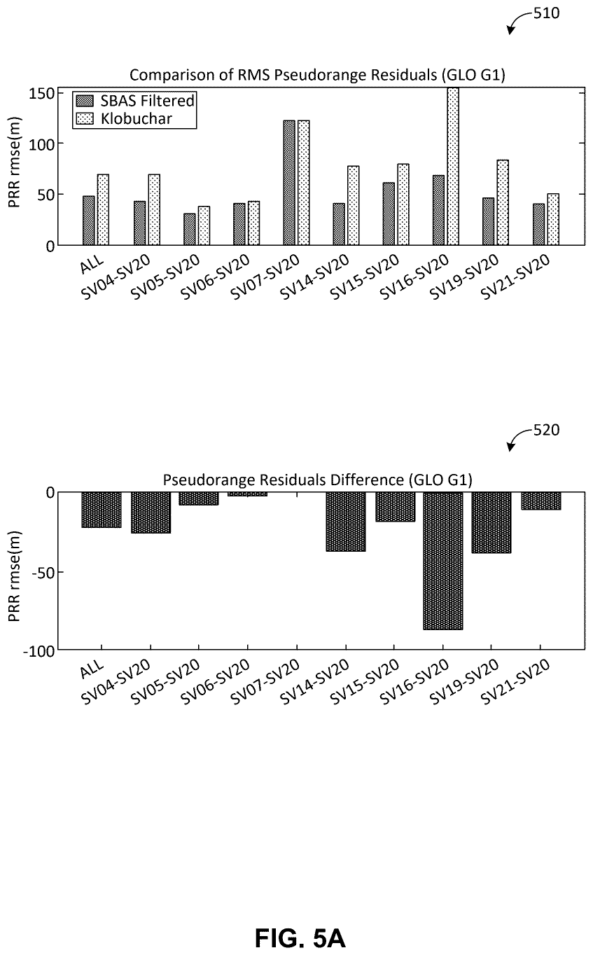

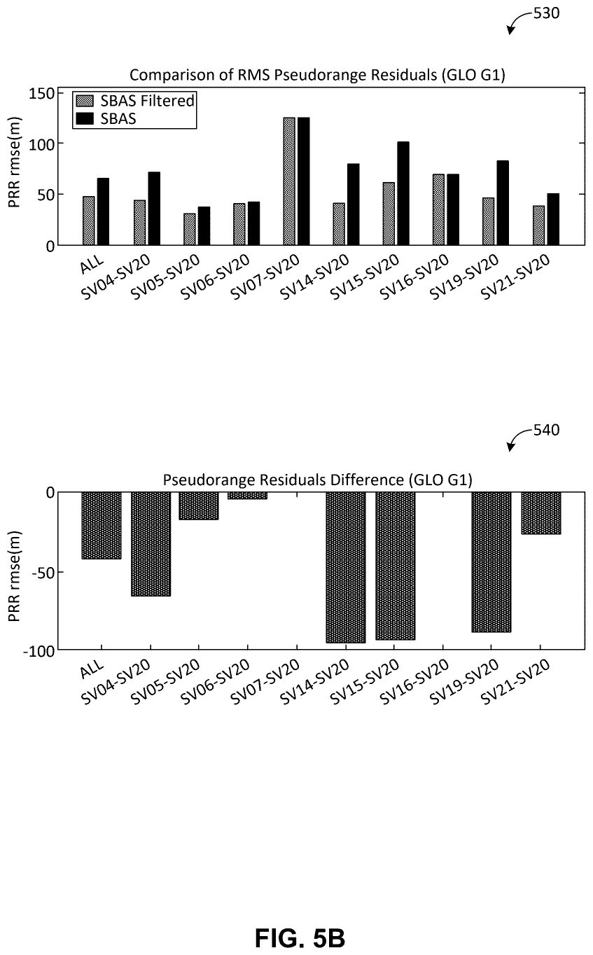

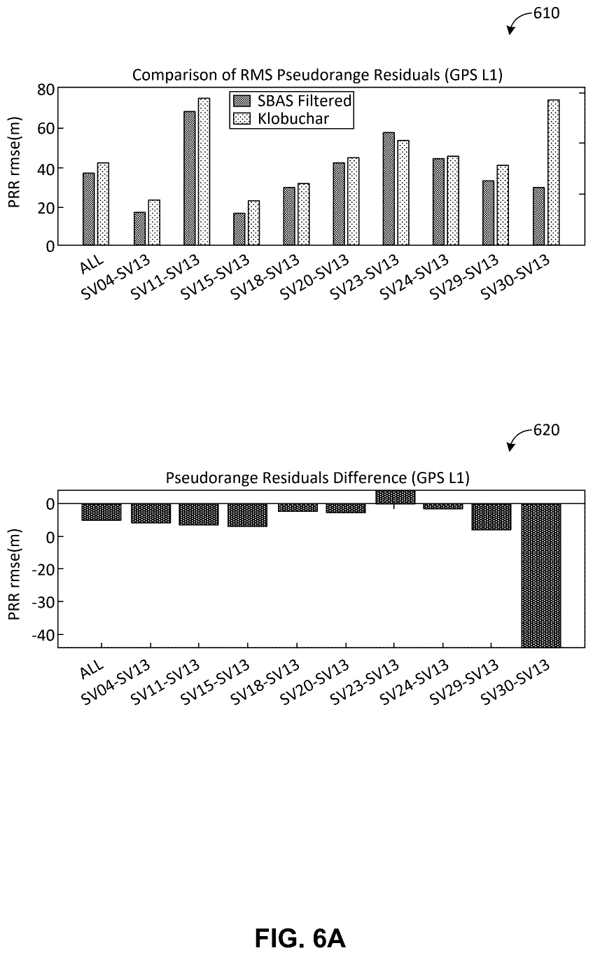

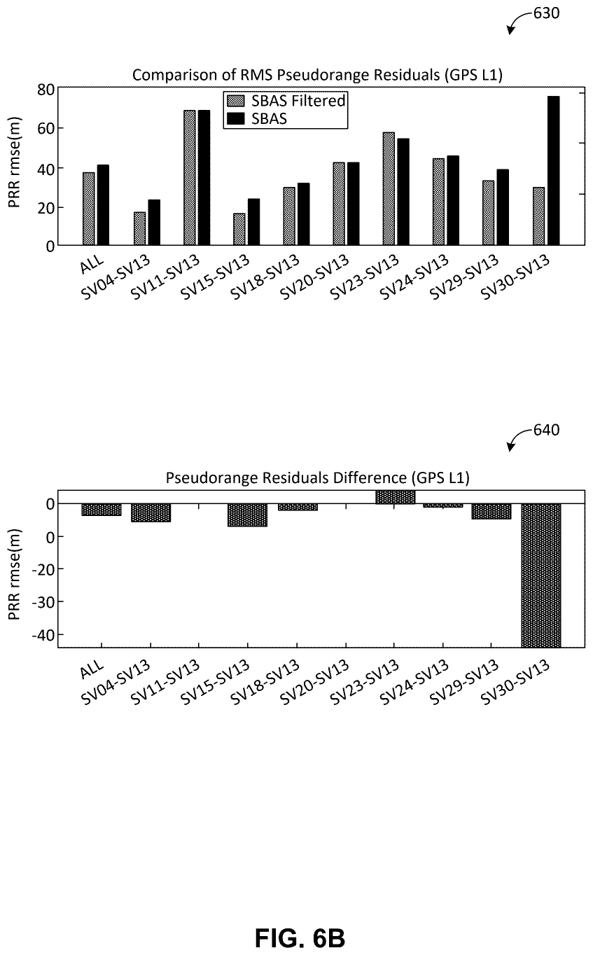

The functionality of the processes 300 and 400 (of FIGS. 3 and 4, respectively) may be performed whenever an iono correction source is used. As previously noted, these processes may be executed by a single GNSS device in some embodiments or may be executed by a combination of devices (e.g., server and GNSS device), depending on desired functionality. This can ultimately improve the GNSS-based position estimates made by the GNSS device. FIGS. 5A-6B, described below, show how these processes 300 and 400 have improved the accuracy in different constellations and/or different data sets.

FIGS. 5A and 5B are graphs showing an example improvement that filtering iono correction in the manner described in the embodiments herein may provide. In this example, PRR (residual) values were determined from GNSS measurements of RF signals transmitted by various satellites using the GLO G1 band. In FIG. 5A, the first graph 510 shows PRR rmse (in meters) for various different GLO satellites, comparing PRR values using traditional Klobuchar iono model (labeled in the first graph 510 as “Klobuchar”) with PRR values using SBAS correction that are filtered using a PEA mask in the manner described in the embodiments above (labeled as “SBAS Filtered”). As can be seen, the PRR value from filtered SBAS for each satellite is as low or lower than the PRR value from traditional Klobuchar. This relationship is shown more clearly in the second graph 520, which plots the difference in PRR values between filtered SBAS and traditional Klobuchar. In all but one instance (SV07-SV20), the plotted values are negative, meaning the PRR value from filtered SBAS is lower than the PRR value from traditional Klobuchar.

FIG. 5B further shows how the usage of filtered SBAS performs against unfiltered SBAS (“SBAS” in FIG. 5B) using the same underlining data set used to generate the graphs of FIG. 5A. Similar to the first graph 510 of FIG. 5A, the first graph 530 of FIG. 5B shows PRR rmse (in meters) for various different GLO satellites. Here, however, the comparison is between PRR values filtered SBAS with PRR values using unfiltered SBAS. As can be seen, the PRR values from filtered SBAS are at least as good, and typically better, than PRR values from unfiltered SBAS. The second graph 540 shows the difference between the residuals in the first graph 530, where it can be seen that the difference is essentially zero for two satellites and negative for the remaining satellites, showing an overall improvement with the use of filtered SBAS.

FIGS. 6A and 6B are graphs like those shown in FIGS. 5A and 5B but using a different constellation and data set. In this example, PRR values were determined from GNSS measurements of RF signals transmitted by various satellites using the GPS L1 band. In FIG. 6A, the first graph 610 shows PRR values for various GPS satellites, comparing PRR values using traditional Klobuchar iono model with PRR values using filtered SBAS. As can be seen, the PRR value from filtered SBAS for all but one satellite (SV23-SV13) is lower than the PRR value from traditional Klobuchar. Again, this relationship is shown more clearly in the second graph 620, which plots the difference in PRR values between filtered SBAS and traditional Klobuchar. In all but the one satellite (SV23-SV13), the plotted values are negative. Overall, the use of filtered SBAS results in a performance increase over the traditional Klobuchar iono model.

FIG. 6B further shows how the usage of filtered SBAS performs against unfiltered SBAS using the same underlining data set used to generate the graphs of FIG. 6A. Like the first graph 610 of FIG. 6A, the first graph 630 of FIG. 6B shows PRR rmse (in meters) for various different GPS satellites. Here, however, the comparison is between PRR values filtered SBAS with PRR values using unfiltered SBAS. The second graph 640 shows the difference between the residuals in the first graph 630. Again, there is a clear performance increase with filtered SBAS versus unfiltered SBAS: PRR values for filtered SBAS are better than PRR values for unfiltered SBAS for at least seven of the nine satellites, at approximately as good for two of the satellites, and slightly worse for one satellite, resulting in an overall decrease in pseudorange values (as indicated by the “ALL” plots in the graphs).

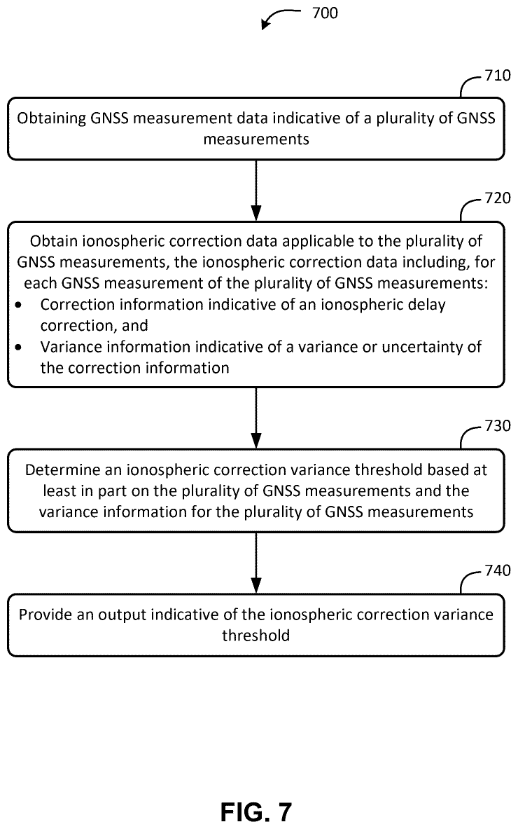

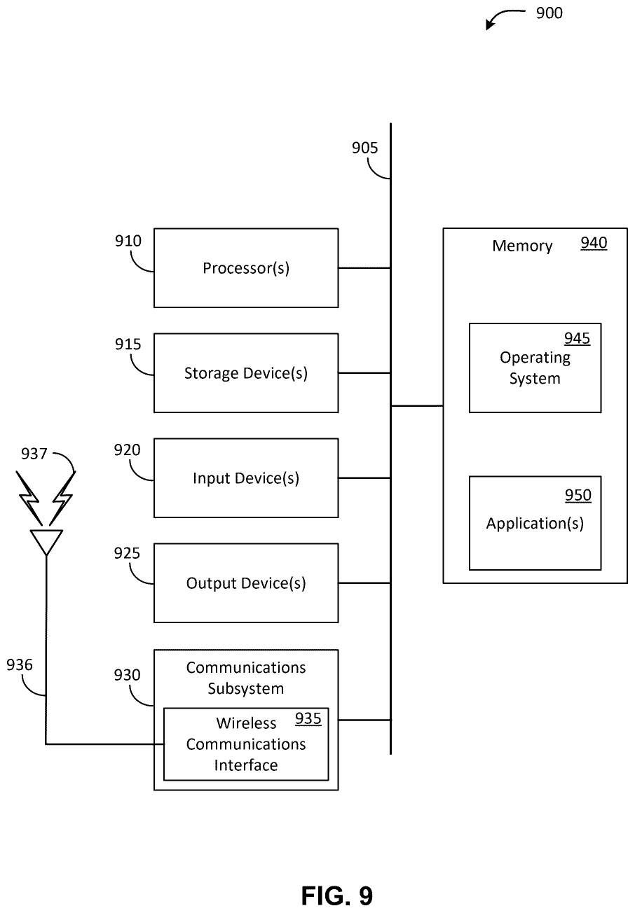

FIG. 7 is a flow chart of a method 700 of supporting GNSS positioning of a GNSS device, according to an example of the present disclosure. According to an example, one or more process blocks of FIG. 7 may be performed by an apparatus, such as the GNSS device or a server. As such, in some embodiments, means and/or structure for performing one or more of the functions shown in the blocks of FIG. 7 may comprise one or more hardware and software components of a GNSS device, such as the GNSS device 800 of FIG. 8, discussed below. In some embodiments, means and/or structure for performing one or more of the functions shown in the blocks of FIG. 7 may comprise one or more hardware and software components of a computer system (e.g., implementing the functionality of a server), such as the computer system 900 of FIG. 9, discussed below.

As shown in FIG. 7, method 700 may include obtaining GNSS measurement data indicative of a plurality of GNSS measurements (block 710). For example, an apparatus may obtain GNSS measurement data indicative of a plurality of GNSS measurements, as described above (e.g., with respect to FIG. 3). As noted, a server may obtain measurement data by crowdsourcing the data from a plurality of GNSS devices, and the measurement data may comprise GNSS measurements taken over a desired period of time.

As noted, means and/or structure for performing the functionality at block 710 may comprise software and/or hardware components of a GNSS device or computer system (e.g., implementing a server). For example, according to some embodiments, such means and/or structure may comprise a bus 805, at least one processor 810, at least one digital signal processor 820, at least one memory 860, at least one wireless communication interface 830 (e.g., comprising one or more transceivers), and/or other components of a GNSS device 800 as shown in FIG. 8 and described below. In another example such means and/or structure may comprise a bus 905, at least one processor 910, at least one memory 940, at least one communications subsystem 930 (e.g., comprising one or more transceivers), and/or other components of a computer system 900 as shown in FIG. 9 and described below.

As also shown in FIG. 7, method 700 may include obtaining ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information (block 720). For example, an apparatus may obtain ionospheric correction data applicable to the plurality of GNSS measurements (e.g., block 320 of FIG. 3), the ionospheric correction data including, for each GNSS measurement of the plurality of GNSS measurements: correction information indicative of an ionospheric delay correction, and variance information indicative of a variance or uncertainty of the correction information, as described above. As previously noted, according to some embodiments, obtaining the ionospheric correction data applicable to the plurality of GNSS measurements may include receiving the correction data applicable to the plurality of GNSS measurements from a Satellite Based Augmentation System (SBAS).

As noted, means and/or structure for performing the functionality at block 720 may comprise software and/or hardware components of a GNSS device or computer system (e.g., implementing a server). For example, according to some embodiments, such means and/or structure may comprise a bus 805, at least one processor 810, at least one digital signal processor 820, at least one memory 860, at least one wireless communication interface 830 (e.g., comprising one or more transceivers), and/or other components of a GNSS device 800 as shown in FIG. 8 and described below. In another example such means and/or structure may comprise a bus 905, at least one processor 910, at least one memory 940, at least one communications subsystem 930 (e.g., comprising one or more transceivers), and/or other components of a computer system 900 as shown in FIG. 9 and described below.

As also shown in FIG. 7, method 700 may include determining an ionospheric correction variance threshold based at least in part on the plurality of GNSS measurements and the variance information for the plurality of GNSS measurements (block 730). For example, an apparatus (e.g., GNSS device or server) may determine an ionospheric correction variance threshold (e.g., PEA mask) based at least in part on the plurality of GNSS measurements and the variance information for the plurality of GNSS measurements, as described above (e.g., with respect to blocks 350-355 of FIG. 3). According to some embodiments, the GNSS measurement data further may include, for each GNSS measurement of the plurality of GNSS measurements: ephemeris data, and ground truth information; and where determining the ionospheric correction variance threshold may include: determining a residual for each GNSS measurement of the plurality of GNSS measurements based at least in part on the GNSS measurement, the ephemeris data and ground truth information of the GNSS measurement, and the ionospheric correction data applicable to the plurality of GNSS measurements; and analyzing residuals of the plurality of GNSS measurements. According to some embodiments, analyzing residuals may include performing a regression analysis. According to some embodiments, determining the ionospheric correction variance threshold may include determining, an average variational coefficient, a median total electron count (TEC) variance, or both. Additional details are provided above (e.g., with respect to FIG. 3).

As noted, means and/or structure for performing the functionality at block 730 may comprise software and/or hardware components of a GNSS device or computer system (e.g., implementing a server). For example, according to some embodiments, such means and/or structure may comprise a bus 805, at least one processor 810, at least one digital signal processor 820, at least one memory 860, at least one wireless communication interface 830 (e.g., comprising one or more transceivers), and/or other components of a GNSS device 800 as shown in FIG. 8 and described below. In another example such means and/or structure may comprise a bus 905, at least one processor 910, at least one memory 940, at least one communications subsystem 930 (e.g., comprising one or more transceivers), and/or other components of a computer system 900 as shown in FIG. 9 and described below.

As further shown in FIG. 7, method 700 may include providing an output indicative of the ionospheric correction variance threshold (block 740). For example, an apparatus (e.g., GNSS device or server) may provide an output indicative of the ionospheric correction variance threshold, as described above. Such an output may comprise an indication of the ionospheric correction variance threshold (e.g., PEA mask) itself, a position estimate determined using the ionospheric correction variance threshold, or the like.

As noted, means and/or structure for performing the functionality at block 740 may comprise software and/or hardware components of a GNSS device or computer system (e.g., implementing a server). For example, according to some embodiments, such means and/or structure may comprise a bus 805, at least one processor 810, at least one digital signal processor 820, at least one memory 860, at least one wireless communication interface 830 (e.g., comprising one or more transceivers), and/or other components of a GNSS device 800 as shown in FIG. 8 and described below. In another example such means and/or structure may comprise a bus 905, at least one processor 910, at least one memory 940, at least one communications subsystem 930 (e.g., comprising one or more transceivers), and/or other components of a computer system 900 as shown in FIG. 9 and described below.

As noted in the embodiments described herein, embodiments may include one or more additional features, depending on desired functionality. For example, if a server executes the method 700 and uses crowdsourcing of GNSS measurements as described herein, then providing the output may include sending the ionospheric correction variance threshold to the GNSS device (e.g., via broadcast, a data communication network, etc.). Such embodiments may include obtaining the GNSS measurement data from a plurality of GNSS devices. According to some embodiments, obtaining the GNSS measurement data, obtaining the ionospheric correction data applicable to the plurality of GNSS measurements, and determining the ionospheric correction variance threshold are performed by the GNSS device. In such embodiments, method 700 may further include performing, with the GNSS device, a set of GNSS measurements, obtaining ionospheric correction data applicable to the set of GNSS measurements, filtering the ionospheric correction data applicable to the set of GNSS measurements based at least in part on the ionospheric correction variance threshold, and determining a location of the GNSS device based at least in part on the filtered the ionospheric correction data and the set of GNSS measurements. (See, e.g., the discussion above with regard to FIG. 4.) In such embodiments, providing the output indicative of the ionospheric correction variance threshold may include providing an output indicative of the determined location of the GNSS device. In such embodiments filtering the ionospheric correction data applicable to the set of GNSS measurements may include determining ionospheric correction data applicable to at least one GNSS measurement of the set of GNSS measurements has a variance that exceeds the ionospheric correction variance threshold, and excluding the ionospheric correction data applicable to the at least one GNSS measurement from the filtered the ionospheric correction data.

It should be noted that while FIG. 7 shows example blocks of method 700, in some implementations, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a block diagram of an embodiment of a GNSS device 800, which can be utilized as described herein above (e.g., in association with FIGS. 1-7). In some embodiments, GNSS device 800 may implement a positioning engine (e.g., a PPE) that can perform some or all of the functionality of the method 700 of FIG. 7 and/or operations of FIGS. 3 and/or 4. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations (and in which case a GNSS position may be determined for the GNSS receiver 880). Furthermore, the GNSS device 800 may be incorporated into another device, such as a cell phone, vehicle, etc., as previously noted.

The GNSS device 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with base stations of a wireless network (e.g. a cellular network), for example, via eNBs, gNBs, ng-eNBs, access points, and/or other access node types, and/or other network components, computer systems, and/or any other electronic devices communicatively coupled with base stations. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and/or other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2 ). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of one or more components and/or devices as described in the embodiments herein. The computer system 900, for example, may be utilized within and/or executed by a server, which may communicate with a GNSS device, iono correction source, and/or other devices or entities as described herein. As such, the computer system 900 may, in some embodiments, perform some or all of the functions of the process 300 of FIG. 3. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 920, which may comprise without limitation a mouse, a keyboard, a camera, a microphone, and/or the like; and one or more output devices 925, which may comprise without limitation a display device, a printer, and/or the like.

The computer system 900 may further include (and/or be in communication with) one or more non-transitory storage devices 915, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 935, as well as wired technologies (such as Ethernet, coaxial communications, universal serial bus (USB), and the like). The wireless communication interface 935 may comprise one or more wireless transceivers that may send and receive wireless signals 937 (e.g., signals according to 5G NR or LTE) via wireless antenna(s) 936. Thus, the communications subsystem 930 may comprise a modem, a network card (wireless or wired), an infrared communication device, a wireless communication device, and/or a chipset, and/or the like, which may enable the computer system 900 to communicate on one or more communication networks and/or to any device on the respective network, GNSS devices and/or other electronic devices described herein. Hence, the communications subsystem 930 may be used to receive and send data as described in the embodiments herein.

In many embodiments, the computer system 900 will further comprise a memory 940, which may comprise a RAM or ROM device, as described above. Software elements, shown as being located within the memory 940, may comprise an operating system 945, device drivers, executable libraries, and/or other code, such as one or more applications 950, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 915 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally, or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of supporting global navigation satellite system (GNSS) positioning of a GNSS device, the method comprising: obtaining GNSS measurement data indicative of a plurality of GNSS measurements; obtaining ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information; determining an ionospheric correction variance threshold based at least in part on the plurality of GNSS measurements and the variance information for the plurality of GNSS measurements; and providing an output indicative of the ionospheric correction variance threshold.
Clause 2: The method of clause 1, wherein obtaining the GNSS measurement data, obtaining the ionospheric correction data applicable to the plurality of GNSS measurements, and determining the ionospheric correction variance threshold are performed by a server, and wherein providing the output comprises sending the ionospheric correction variance threshold to the GNSS device.
Clause 3: The method of clause 2, further comprising obtaining the GNSS measurement data from a plurality of GNSS devices.
Clause 4: The method of any one of clauses 1-3, wherein the GNSS measurement data further comprises, for each GNSS measurement of the plurality of GNSS measurements: ephemeris data, and ground truth information; and wherein determining the ionospheric correction variance threshold comprises: determining a residual for each GNSS measurement of the plurality of GNSS measurements based at least in part on the GNSS measurement, the ephemeris data and ground truth information of the GNSS measurement, and the ionospheric correction data applicable to the plurality of GNSS measurements; and analyzing residuals of the plurality of GNSS measurements.
Clause 5: The method of clause 4, wherein analyzing residuals comprises performing a regression analysis.
Clause 6: The method of any one of clauses 1-5, wherein determining the ionospheric correction variance threshold comprises determining, an average variational coefficient, a median total electron count (TEC) variance, or both.
Clause 7: The method of any one of clauses 1-6, wherein obtaining the GNSS measurement data, obtaining the ionospheric correction data applicable to the plurality of GNSS measurements, and determining the ionospheric correction variance threshold are performed by the GNSS device.
Clause 8: The method of clause 7, further comprising: performing, with the GNSS device, a set of GNSS measurements; obtaining ionospheric correction data applicable to the set of GNSS measurements; filtering the ionospheric correction data applicable to the set of GNSS measurements based at least in part on the ionospheric correction variance threshold; and determining a location of the GNSS device based at least in part on the filtered the ionospheric correction data and the set of GNSS measurements; wherein providing the output indicative of the ionospheric correction variance threshold comprises providing an output indicative of the determined location of the GNSS device.
Clause 9: The method of clause 8, wherein filtering the ionospheric correction data applicable to the set of GNSS measurements comprises: determining ionospheric correction data applicable to at least one GNSS measurement of the set of GNSS measurements has a variance that exceeds the ionospheric correction variance threshold; and excluding the ionospheric correction data applicable to the at least one GNSS measurement from the filtered the ionospheric correction data.
Clause 10: The method of any one of clauses 1-9, wherein obtaining the ionospheric correction data applicable to the plurality of GNSS measurements comprises receiving the correction data applicable to the plurality of GNSS measurements from a Satellite Based Augmentation System (SBAS).
Clause 11: An apparatus for supporting global navigation satellite system (GNSS) positioning of a GNSS device, the apparatus comprising: at least one transceiver; at least one memory; and at least one processor communicatively coupled with the at least one transceiver and at least one memory, the at least one processor configured to: obtain GNSS measurement data indicative of a plurality of GNSS measurements; obtain ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information; determine an ionospheric correction variance threshold based at least in part on the plurality of GNSS measurements and the variance information for the plurality of GNSS measurements; and provide an output indicative of the ionospheric correction variance threshold.
Clause 12: The apparatus of clause 11, wherein the apparatus comprises a server, and wherein the at least one processor is configured to send the ionospheric correction variance threshold to the GNSS device via the at least one transceiver.
Clause 13: The apparatus of clause 12, wherein the at least one processor is further configured to obtain the GNSS measurement data from a plurality of GNSS devices the at least one transceiver.
Clause 14: The apparatus of any one of clauses 11-13, wherein the GNSS measurement data further comprises, for each GNSS measurement of the plurality of GNSS measurements: ephemeris data, and, ground truth information; and wherein to determine the ionospheric correction variance threshold, the at least one processor is configured to: determine a residual for each GNSS measurement of the plurality of GNSS measurements based at least in part on the GNSS measurement, the ephemeris data and ground truth information of the GNSS measurement, and the ionospheric correction data applicable to the plurality of GNSS measurements; and analyze residuals of the plurality of GNSS measurements.
Clause 15: The apparatus of any one of clauses 11-14, wherein, to determine the ionospheric correction variance threshold, the at least one processor is configured to determine an average variational coefficient, a median total electron count (TEC) variance, or both.
Clause 16: The apparatus of any one of clauses 11-15, wherein the apparatus comprises the GNSS device.
Clause 17: The apparatus of clause 16, further comprising a GNSS receiver, wherein the at least one processor is further configured to: perform, with the GNSS receiver, a set of GNSS measurements; obtain ionospheric correction data applicable to the set of GNSS measurements; filter the ionospheric correction data applicable to the set of GNSS measurements based at least in part on the ionospheric correction variance threshold; and determine a location of the GNSS device based at least in part on the filtered the ionospheric correction data and the set of GNSS measurements; and wherein, to provide the output indicative of the ionospheric correction variance threshold, the at least one processor is configured to provide an output indicative of the determined location of the GNSS device.
Clause 18: The apparatus of clause 17, wherein, to filter the ionospheric correction data applicable to the set of GNSS measurements, the at least one processor is configured to: determine ionospheric correction data applicable to at least one GNSS measurement of the set of GNSS measurements has a variance that exceeds the ionospheric correction variance threshold; and exclude the ionospheric correction data applicable to the at least one GNSS measurement from the filtered the ionospheric correction data.
Clause 19: The apparatus of any one of clauses 11-18, wherein, to obtain the ionospheric correction data applicable to the plurality of GNSS measurements, the at least one processor is configured to receive the correction data applicable to the plurality of GNSS measurements from a Satellite Based Augmentation System (SBAS).
Clause 20: An apparatus comprising: means for obtaining global navigation satellite system (GNSS) measurement data indicative of a plurality of GNSS measurements; means for obtaining ionospheric correction data applicable to the plurality of GNSS measurements, the ionospheric correction data including, for each GNSS measurement of the plurality of GNSS measurements: correction information indicative of an ionospheric delay correction, and variance information indicative of a variance or uncertainty of the correction information; means for determining an ionospheric correction variance threshold based at least in part on the plurality of GNSS measurements and the variance information for the plurality of GNSS measurements; and means for providing an output indicative of the ionospheric correction variance threshold.
Clause 21: An apparatus having means for performing the method of any one of clauses 1-10.
Clause 22: A non-transitory computer-readable medium storing instructions, the instructions comprising code for performing the method of any one of clauses 1-10.

What is claimed is:

1. A method of supporting global navigation satellite system (GNSS) positioning of a GNSS device, the method comprising:
obtaining GNSS measurement data indicative of a plurality of GNSS measurements;
obtaining ionospheric correction data applicable to the plurality of GNSS measurements, the ionospheric correction data including, for each GNSS measurement of the plurality of GNSS measurements:
correction information indicative of an ionospheric delay correction, and
variance information indicative of a variance or uncertainty of the correction information;
determining an ionospheric correction variance threshold based at least in part on the plurality of GNSS measurements and the variance information for the plurality of GNSS measurements; and
providing an output indicative of the ionospheric correction variance threshold.

2. The method of claim 1, wherein obtaining the GNSS measurement data, obtaining the ionospheric correction data applicable to the plurality of GNSS measurements, and determining the ionospheric correction variance threshold are performed by a server, and wherein providing the output comprises sending the ionospheric correction variance threshold to the GNSS device.

3. The method of claim 2, further comprising obtaining the GNSS measurement data from a plurality of GNSS devices.

4. The method of claim 1, wherein the GNSS measurement data further comprises, for each GNSS measurement of the plurality of GNSS measurements:
ephemeris data, and
ground truth information; and
wherein determining the ionospheric correction variance threshold comprises:
determining a residual for each GNSS measurement of the plurality of GNSS measurements based at least in part on the GNSS measurement, the ephemeris data and ground truth information of the GNSS measurement, and the ionospheric correction data applicable to the plurality of GNSS measurements; and
analyzing residuals of the plurality of GNSS measurements.

5. The method of claim 4, wherein analyzing residuals comprises performing a regression analysis.

6. The method of claim 1, wherein determining the ionospheric correction variance threshold comprises determining, an average variational coefficient, a median total electron count (TEC) variance, or both.

7. The method of claim 1, wherein obtaining the GNSS measurement data, obtaining the ionospheric correction data applicable to the plurality of GNSS measurements, and determining the ionospheric correction variance threshold are performed by the GNSS device.

8. The method of claim 7, further comprising:
performing, with the GNSS device, a set of GNSS measurements;
obtaining ionospheric correction data applicable to the set of GNSS measurements;
filtering the ionospheric correction data applicable to the set of GNSS measurements based at least in part on the ionospheric correction variance threshold; and
determining a location of the GNSS device based at least in part on the filtered the ionospheric correction data and the set of GNSS measurements;
wherein providing the output indicative of the ionospheric correction variance threshold comprises providing an output indicative of the determined location of the GNSS device.

9. The method of claim 8, wherein filtering the ionospheric correction data applicable to the set of GNSS measurements comprises:
determining ionospheric correction data applicable to at least one GNSS measurement of the set of GNSS measurements has a variance that exceeds the ionospheric correction variance threshold; and
excluding the ionospheric correction data applicable to the at least one GNSS measurement from the filtered the ionospheric correction data.

10. The method of claim 1, wherein obtaining the ionospheric correction data applicable to the plurality of GNSS measurements comprises receiving the correction data applicable to the plurality of GNSS measurements from a Satellite Based Augmentation System (SBAS).

11. An apparatus for supporting global navigation satellite system (GNSS) positioning of a GNSS device, the apparatus comprising:
at least one transceiver;
at least one memory; and
at least one processor communicatively coupled with the at least one transceiver and at least one memory, the at least one processor configured to:
obtain GNSS measurement data indicative of a plurality of GNSS measurements;
obtain ionospheric correction data applicable to the plurality of GNSS measurements, the ionospheric correction data including, for each GNSS measurement of the plurality of GNSS measurements:
correction information indicative of an ionospheric delay correction, and
variance information indicative of a variance or uncertainty of the correction information;
determine an ionospheric correction variance threshold based at least in part on the plurality of GNSS measurements and the variance information for the plurality of GNSS measurements; and
provide an output indicative of the ionospheric correction variance threshold.

12. The apparatus of claim 11, wherein the apparatus comprises a server, and wherein the at least one processor is configured to send the ionospheric correction variance threshold to the GNSS device via the at least one transceiver.

13. The apparatus of claim 12, wherein the at least one processor is further configured to obtain the GNSS measurement data from a plurality of GNSS devices the at least one transceiver.

14. The apparatus of claim 11, wherein the GNSS measurement data further comprises, for each GNSS measurement of the plurality of GNSS measurements:
ephemeris data, and,
ground truth information; and
wherein to determine the ionospheric correction variance threshold, the at least one processor is configured to:
determine a residual for each GNSS measurement of the plurality of GNSS measurements based at least in part on the GNSS measurement, the ephemeris data and ground truth information of the GNSS measurement, and the ionospheric correction data applicable to the plurality of GNSS measurements; and
analyze residuals of the plurality of GNSS measurements.

15. The apparatus of claim 11, wherein, to determine the ionospheric correction variance threshold, the at least one processor is configured to determine an average variational coefficient, a median total electron count (TEC) variance, or both.

16. The apparatus of claim 11, wherein the apparatus comprises the GNSS device.

17. The apparatus of claim 16, further comprising a GNSS receiver, wherein the at least one processor is further configured to:
perform, with the GNSS receiver, a set of GNSS measurements;
obtain ionospheric correction data applicable to the set of GNSS measurements;
filter the ionospheric correction data applicable to the set of GNSS measurements based at least in part on the ionospheric correction variance threshold;
and determine a location of the GNSS device based at least in part on the filtered the ionospheric correction data and the set of GNSS measurements; and
wherein, to provide the output indicative of the ionospheric correction variance threshold, the at least one processor is configured to provide an output indicative of the determined location of the GNSS device.

18. The apparatus of claim 17, wherein, to filter the ionospheric correction data applicable to the set of GNSS measurements, the at least one processor is configured to:
determine ionospheric correction data applicable to at least one GNSS measurement of the set of GNSS measurements has a variance that exceeds the ionospheric correction variance threshold; and
exclude the ionospheric correction data applicable to the at least one GNSS measurement from the filtered the ionospheric correction data.

19. The apparatus of claim 11, wherein, to obtain the ionospheric correction data applicable to the plurality of GNSS measurements, the at least one processor is configured to receive the correction data applicable to the plurality of GNSS measurements from a Satellite Based Augmentation System (SBAS).

20. An apparatus comprising:
means for obtaining global navigation satellite system (GNSS) measurement data indicative of a plurality of GNSS measurements;
means for obtaining ionospheric correction data applicable to the plurality of GNSS measurements, the ionospheric correction data including, for each GNSS measurement of the plurality of GNSS measurements:
correction information indicative of an ionospheric delay correction, and
variance information indicative of a variance or uncertainty of the correction information;
means for determining an ionospheric correction variance threshold based at least in part on the plurality of GNSS measurements and the variance information for the plurality of GNSS measurements; and
means for providing an output indicative of the ionospheric correction variance threshold.
